(19) United States
(12) Patent Application Publication
(10) Pub. No.: US 2016/0260013 A1
(43) Pub. Date: Sep. 8, 2016

(54) METHOD AND APPARATUS FOR OPTIMIZATION

(71) Applicant: Nokia Technologies Oy, Espoo (FI)

(72) Inventors: Troels Frimodt Rønnow, Cambridge (GB); Joachim Wabnig, Upper Cambourne (GB); Antti Niskanen, Cambridge (GB)

(21) Appl. No.: 14/640,510

(22) Filed: Mar. 6, 2015

(51) Int. Cl. G06N 3/08

(52) U.S. Cl. CPC G06N 3/08

(57) ABSTRACT

An approach is provided for solving optimization problems. The present invention also relates to a method comprising obtaining a first set of binary variables and a second set of binary variables; providing information regarding interactions between binary variables of the first set and binary variables of the second set; and providing an inverse temperature value. A change of a local energy of a binary variable of the first set if the binary variable were flipped is calculated on the basis of the inverse temperature value and the interactions between the binary variable of the first set and binary variables of the second set; and a probability is calculated on the basis of the change of the local energy. The probability is compared to a random value to determine whether to accept the flipping of the binary variable of the first set; and if the comparison indicates that the flipping can be accepted, the value of the binary variable of the first set is flipped. There is also disclosed an apparatus for implementing the method.

### TECHNOLOGICAL FIELD

The present invention relates generally to solving optimization problems. More particularly, the present invention relates to a method for finding a solution to quadratic binary optimization problems. The present invention also relates to apparatuses and computer program products for implementing the method and circuitry relating to the quadratic binary optimization.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Quadratic binary optimization (QUBO) is a particular type of problems. Such problems may be both extremely awkward for digital computers and important. Many cutting-edge artificial intelligence (AI) involves solving such problems. A Boltzmann machine may solve binary optimization and may accelerate sampling from a Boltzmann distribution.

An aim of the quadratic binary optimization is to minimize a quadratic function in which decision variables may only take certain discrete values, such as +1 and −1. The idea of quadratic binary optimization may be adapted to different kinds of programmable circuits. Quadratic binary optimization problems may arise in operational research such as planning, scheduling, routing, finance such as portfolio optimization, physics such as spin glass, machine learning and many more.

### Some Exemplary Embodiments

Examples of hardware architecture for discrete optimization and a programming method are provided. Specifically, examples are provided which represent a variant of quadratic binary optimization.

An aim is to obtain an apparatus and method for solving optimization problems.

According to one embodiment, an apparatus comprises

a first input for receiving a first set of binary variables and a second set of binary variables;

a first element for storing information regarding interactions between binary variables of the first set and binary variables of the second set;

a second input for receiving an inverse temperature value;

a second element for calculating a change of a local energy of a binary variable of the first set if the binary variable were flipped on the basis of the inverse temperature value and the interactions between the binary variable of the first set and binary variables of the second set;

a third element for calculating a probability on the basis of the change of the local energy;

a fourth element for comparing the probability to a random value to determine whether to accept the flipping of the binary variable of the first set; and

a fifth element for providing an indication whether the flipping can be accepted; and

a sixth element for providing the flipped value of the binary variable of the first set.

According to one embodiment, a method comprises

obtaining a first set of binary variables and a second set of binary variables;

providing information regarding interactions between binary variables of the first set and binary variables of the second set;

providing an inverse temperature value;

calculating a change of a local energy of a binary variable of the first set if the binary variable were flipped on the basis of the inverse temperature value and the interactions between the binary variable of the first set and binary variables of the second set;

calculating a probability on the basis of the change of the local energy;

comparing the probability to a random value to determine whether to accept the flipping of the binary variable of the first set; and

if the comparison indicates that the flipping can be accepted, flipping the value of the binary variable of the first set.

According to one embodiment, an apparatus comprises at least one processor; and at least one memory including computer program code the at least one memory and the computer program code configured to, with the at least one processor, cause the apparatus to perform at least the following:

obtain a first set of binary variables and a second set of binary variables;

provide information regarding interactions between binary variables of the first set and binary variables of the second set;

provide an inverse temperature value;

calculate a change of a local energy of a binary variable of the first set if the binary variable were flipped on the basis of the inverse temperature value and the interactions between the binary variable of the first set and binary variables of the second set;

calculate a probability on the basis of the change of the local energy;

compare the probability to a random value to determine whether to accept the flipping of the binary variable of the first set; and if the comparison indicates that the flipping can be accepted, flip the value of the binary variable of the first set.

Still other aspects, features, and advantages of the invention are readily apparent from the following detailed description, simply by illustrating a number of particular embodiments and implementations.

The invention is also capable of other and different embodiments, and its several details can be modified in various obvious respects, all without departing from the spirit and scope of the invention. Accordingly, the drawings and description are to be regarded as illustrative in nature, and not as restrictive.

There is provided examples of a scalable architecture for quadratic binary optimization. An advantage of employing a computational architecture is that it may simulate a physical system relatively fast and could either be a part of system-on-chip (SoC), used as a massively parallel device for training and prediction in machine learning, to study physics problems, etc. In all these cases, the computational architecture according to an embodiment may make low-power consumption and fast execution time possible.

### BRIEF DESCRIPTION OF THE DRAWINGS

The embodiments of the invention are illustrated by way of example, and not by way of limitation, in the figures of the accompanying drawings:

FIG. 1 depicts an example of a fully bipartite graph according to an exemplary embodiment;

FIG. 2a depicts symbols used in the Figures for a single bit, a sign, an exponent and a mantissa;

FIG. 2b depicts a symbol used in the Figures for integers;

FIG. 2c depicts a symbol used in the Figures for floating point numbers;

FIG. 2d depicts a symbol used in the Figures for representing exponents and mantissa bits;

FIG. 3a depicts a logic for binary variable multiplication, in accordance with an embodiment;

FIG. 3b depicts a representation corresponding to the logic for binary variable multiplication of FIG. 3a, in accordance with an embodiment;

FIG. 4a depicts a tree reduction unit, in accordance with an embodiment;

FIG. 4b depicts a representation corresponding to the tree reduction unit of FIG. 4a, in accordance with an embodiment;

FIG. 5a depicts a vector-vector reduction unit, in accordance with an embodiment;

FIG. 5b depicts a representation corresponding to the vector-vector reduction unit of FIG. 5a, in accordance with an embodiment;

FIG. 6a depicts a latch, in accordance with an embodiment;

FIG. 6b depicts a representation corresponding to the latch of FIG. 6a, in accordance with an embodiment;

FIG. 6c depicts an N-latch, in accordance with an embodiment;

FIG. 6d depicts a representation corresponding to the N-latch of FIG. 6c, in accordance with an embodiment;

FIG. 7a depicts an exponential approximation unit, in accordance with an embodiment;

FIG. 7b depicts a representation corresponding to the exponential approximation unit of FIG. 7a, in accordance with an embodiment;

FIG. 8a depicts an accept move decision unit, in accordance with an embodiment;

FIG. 8b depicts a representation corresponding to the accept move decision unit of FIG. 8a, in accordance with an embodiment;

FIG. 9a depicts a single-spin computation unit, in accordance with an embodiment;

FIG. 9b depicts a representation corresponding to the single-spin computation unit of FIG. 9a, in accordance with an embodiment;

FIG. 10a depicts a bipartite half update unit, in accordance with an embodiment;

FIG. 10b depicts a representation corresponding to the bipartite half update unit of FIG. 10a, in accordance with an embodiment;

FIG. 11a depicts a full update unit, in accordance with an embodiment;

FIG. 11b depicts a representation corresponding to the full update unit of FIG. 10a, in accordance with an embodiment;

FIG. 12 depicts an example of a computational architecture for quadratic binary optimization, in accordance with an embodiment;

FIG. 13 is a diagram of some components of a computing apparatus comprising the computational architecture for quadratic binary optimization according to an exemplary embodiment.

### DESCRIPTION OF EXAMPLE EMBODIMENTS

In the following description, for the purposes of explanation, some specific details are set forth in order to provide a thorough understanding of the embodiments of the invention. It is apparent, however, to one skilled in the art that the embodiments may be practiced without these specific details or with an equivalent arrangement. In other instances, well-known structures and devices are shown in block diagram form in order to avoid unnecessarily obscuring the embodiments of the invention.

Embodiments are provided to show how to implement in hardware quadratic binary optimization.

A quadratic binary optimization problem may be formulated e.g. in the following way: Given a real-valued matrix A of dimensions N×N and a real-valued vector B of length N, a binary vector b may be found out such that the energy (or cost function)

E=b·A·b+B·b (1)

is minimized. A related problem is to obtain samples from a probability distribution defined by the energy function in Eq. (1) as

$$p ( {b}_{i} ) = \frac{1}{Z} {e}^{- β ( {b}_{i} \cdot A \cdot {b}_{i} + B \cdot {b}_{i} )} \qquad ( 2 )$$

with the normalizing partition function given by

$$Z = {\sum }_{i} {e}^{- β ( {b}_{i} \cdot A \cdot {b}_{i} + B \cdot {b}_{i} )} \qquad ( 3 )$$

where the summation i runs over all possible bit combinations. Sampling is one building block for stochastic statistical models in machine learning.

Some methods to solve the minimization and sampling problem are the closely related simulated annealing and Markov Chain Monte Carlo (MCMC) methods. To make the connection with a physical system the energy function Eq. (1) can be recast in terms of the spin variables.

$$\begin{matrix}s = 1 - 2 b \\ as & ( 4 ) \\ Z = {\sum }_{i}^{N} {\sum }_{j}^{i - 1} {J}_{ij} {s}_{i} {s}_{j} + {\sum }_{i}^{N} {h}_{i} {s}_{i} & ( 5 )\end{matrix}$$

where Jᵢⱼ and hᵢ are floating points (possibly negative) and sᵢ are representing physical spins that can either be up or down. The variables Jᵢⱼ represent interactions between spins sᵢ and sⱼ and hᵢ represents an external field affecting to the spin sᵢ.

The variables sᵢ can take the values {+1, −1}. To obtain a sample from the energy distribution the following algorithm may be performed: starting from a random spin configuration a new configuration may be suggested. Based on the energy difference between the old and the new state the new configuration may be accepted according to a Boltzmann factor e^{βΔE}, where β=T⁻¹ is the inverse of the temperature T. In its simplest form, a single spin sᵢ may be chosen and the energy gain/loss if that spin is flipped may be computed as follows:

ΔE=−2Eᵢ (6)

which is always equal to minus two times the local spin energy

$${E}_{i} = {s}_{i} ( {h}_{i} + {\sum }_{j}^{2 N} {J}_{ij} {s}_{j} ) \qquad ( 7 )$$

If the energy difference is negative the new configuration may be accepted. If the energy difference is positive a random number r ∈ [0; 1] may be drawn and the configuration may be accepted if e^{-βΔE}>r. Then the next spin may be chosen and possibly flipped. In simulated annealing, the inverse temperature is increased after each attempted configuration change according to a defined annealing schedule. i=1 . . . 2N; j=1 . . . N, N+1 . . . 2N.

Implementing simulated annealing on general purpose hardware (central processing unit, CPU; graphics processing unit, GPU) may suffer from several limitations such as limited parallelism in the energy calculation, limited parallelism in random number generation, inefficient energy calculation for binary variables, inefficient calculation of exponential functions, a need for non-local memory access. Each of the above-listed points can form a bottleneck in a simulated annealing calculation.

An approach to realize sampling and minimization is using a physical implementation. While functional the quantum annealing technology may suffer from a limited range, calibration errors and programming/readout overheads and may currently not be efficiently simulated on personal computers.

Some implementations of simulated annealing (SA) as algorithms may include codes specialized for certain types of problems, cluster update codes and special purpose field programmable gate array (FPGA) hardware. These approaches may rely on graphs with sparse connectivity and most of them on graphs with low- range couplings. If one makes a state-of-the-art optimized implementation, performance may be gained at the expense of coupling precision. Cluster algorithms have some great advantages on non-frustrated problems, but may fail if a given problem has a lot of frustration. Finally, the attempts that have been devoted to deploy SA on FPGAs have been using limited coupling precision.

In an FPGA implementation a time consuming part may be to select states according to a Boltzmann distribution which may be done by suggesting a new state and perform the move with a probability proportional to the exponential of energy difference between the two states, θ^{-β(E′-E)} where E is the energy before the move and E′ is the energy after. This procedure may comprise two parts: 1) computing the exponential and 2) heuristically deciding whether a move should be made.

Some approaches may be limited to ±J couplings if performance needs to be high. The reason for this is that with this construct all multiplications can be carried out with bit manipulations, and the resulting energy difference obtained only has possible limited number of outcomes (as opposed to floating-points where the number of possible outcomes grows exponentially in the number of neighbors). With a small number of gates, a lookup table can now be constructed, and exponentials of the flipping energy can easily be computed. This is, however, not the case if floating-point precision is used. Here, computing the exponential may be a complex and very expensive task in terms of computing resources.

Another approach is linear interpolation of the exponential. However, such an approach may lead either to considerable errors, or to a considerable number of segments. In an embodiment a couple of (e.g. 3-4) standard floating point operations may be used to perform the linear interpolation over a certain number of segments (e.g. 2047 segments), and after that, a correction table may be applied to improve the result. This may lead to a quite accurate exponential approximation which uses “few” gates (few compared to an exact implementation) and therefore may be deployed without concerns about the spatial occupancy of this part of the circuit. This may allow deployment of many of the exponential functions in parallel which would otherwise not be possible.

In the following, a computational architecture which can be used in machine learning and to solve hard optimization problems is explained in more detail.

In accordance with an embodiment, the computational architecture may be used for e.g. simulating thermal cooling of Ising spin glasses using “simulated annealing”. Simulated annealing (SA) simulates the thermal equilibrium distributions of states in Ising spin glasses. The computational architecture may be realized e.g. as an FPGA or ASIC implementation which performs SA of an Ising spin glass on a bipartite graph. The computational architecture may implement several sub-modules and combinations of the sub-modules. Some of those modules are shortly described in the following.

A sub-module may be a matrix-vector multiplication module which uses bit operations for the multiplication, and a log(N) reduction-tree to compute the sum. Unlike simulation on general purpose hardware, multiplication may be carried out using bitwise XOR operations, yet this implementation has floating point precision.

Another sub-module may either perform exponential approximation or logarithmic approximation.

A sub-module may comprise a fully connected bipartite graph on which certain problems may be embedded with no overhead. This sub-module may be formed from one or more of the above mentioned sub-modules.

A combination of the above mentioned and possibly some further sub-modules may build up an architecture for solving optimization problems and for running Boltzmann machine problems.

Further details of the sub-modules and the architecture will be provided later in this specification.

In accordance with an embodiment, a fully connected bipartite graph with 2N spins may be implemented. The implementation may be generalized to perform simulated quantum annealing using discretization of path integrals. This may be done by making selected couplings variable over time.

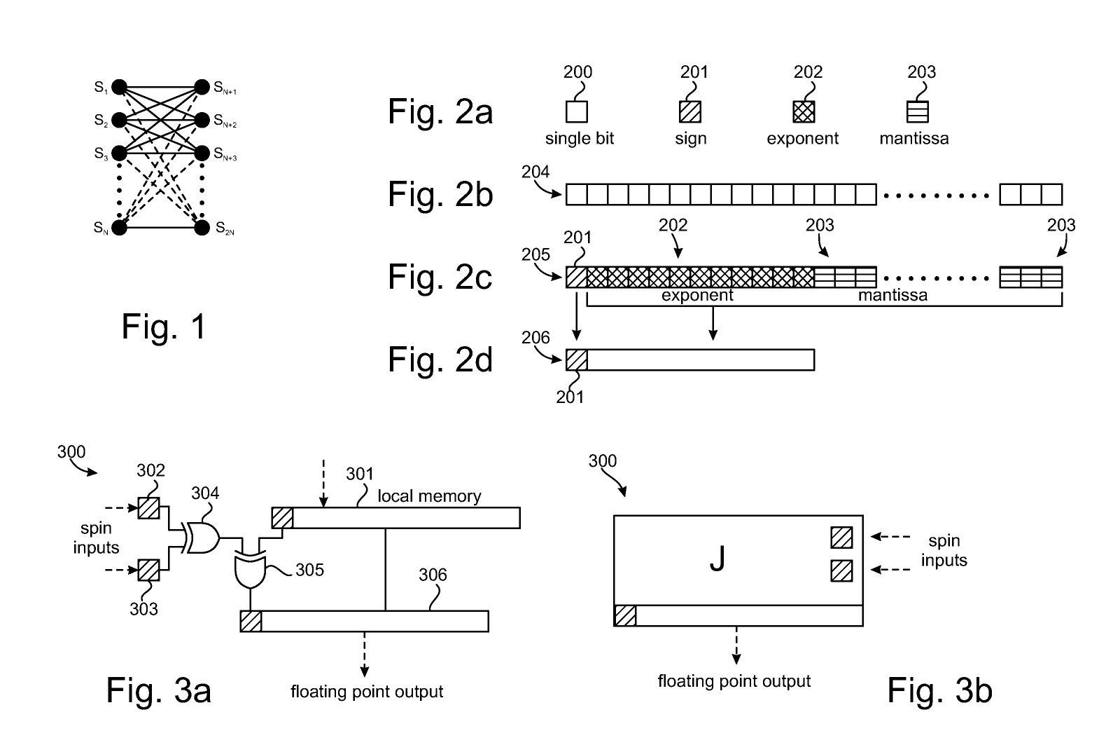

FIG. 1 depicts an example of a fully bipartite graph. It can be noted that the local energy of two spins belonging to the same half are independent of each other. That is to say, if the spins i and j both belong to the right half of FIG. 1, then flipping one does not change the local energy of the other. Consequently, one can update all the spins of one-half of the graph simultaneously and after that all the spins of the other half.

In the following, it is assumed that the graph has N=2^{M} spins where M is an integer. This assumption is not necessary, but may be useful for practical purposes as the circuits scale in a natural way in N if this requirement is met. It will also be assumed that couplings are floating points, but the following approach can trivially be reformulated using integer couplings.

Throughout this specification, single bits, integers and floating points are mainly used in the schematic representations. These have been illustrated in FIGS. 2a-2d. Although some of the schematics will use integers of a fixed size, the ideas are general and can be realized using arbitrary size integers and floating points. Some standard arithmetic is also used to shorten the diagrams as follows: Spins are represented as binary variables such as bits: If s denotes the spin and b denotes the binary variable, then b=1 corresponds to s=−1 and b=0 to s=1, or equivalently s=1-2b. For single bit operations, standard gate symbols will be used. For simplicity, illustrations of inputs and outputs are also omitted in most of the Figures.

FIG. 2a depicts symbols used in the Figures for a single bit, a sign, an exponent and a mantissa. The fill pattern indicates what the interpretation of the bits is: a blank square 200 is used for integer sequences; a diagonal striped square 201 is used for signs; a crosswise striped square 202 is used for exponents in floating points; and a horizontally striped square 203 is used for the mantissa. Integers are represented as a sequence of bits with no pattern or filling, as is illustrated in FIG. 2b with the reference number 204. Two representations are used of floating points: the full bitwise representation consisting of a sign 201, an exponent 203 and mantissa bits 204, as is illustrated in FIG. 2c with the reference number 205; and the representation consisting of a sign and a blank section representing the exponent and mantissa bits, illustrated in FIG. 2d with the reference number 206. In addition to the type representations, four symbols are also used to represent high-level operations between two floating points, namely, a plus sign inside a circle defines the logic for adding two floating points; an X inside a circle defines the logic for multiplying two floating points; a less than sign inside a circle defines the logic for comparing two floating points; and a slash sign inside a circle defines the logic for dividing two floating points.

FIG. 3a depicts the logic for spin multiplication, and FIG. 3b depicts a corresponding representation of the logic in a reduced form to be used in further illustrations of the apparatus, in accordance with an embodiment. The spin multiplication unit 300 comprises a local floating point memory J[1:N] and spin inputs (in bit-representation) bᵢ 302 and bⱼ 303.

Computing the local energy Eᵢ may be carried out by computing sums of terms given as sᵢsⱼJᵢⱼ. The role of the sᵢ and sⱼ is to alter the sign of the energy contribution, and with the notion sᵢ=1-2bᵢ this may be implemented using standard logic by using two XOR gates 304, 305 to multiply the sign bit of Jᵢⱼ as depicted in FIG. 3a. The sign sᵢ 302 is input to a first input of the first XOR gate 304 and the sign sⱼ 303 is input to a second input of the first XOR gate 304. The output of the first XOR gate 304 is connected to a first input of the second XOR gate 305. The second XOR gate 305 receives at the second input the sign bit of the floating point value 301 stored into a local memory. The circuit produces the output O[1:N] as

O[1:N−1]=J[1:N−1]

O[N]=bᵢ xor bⱼ xor J[N]

Programming inputs for the local memory are omitted in the schematics.

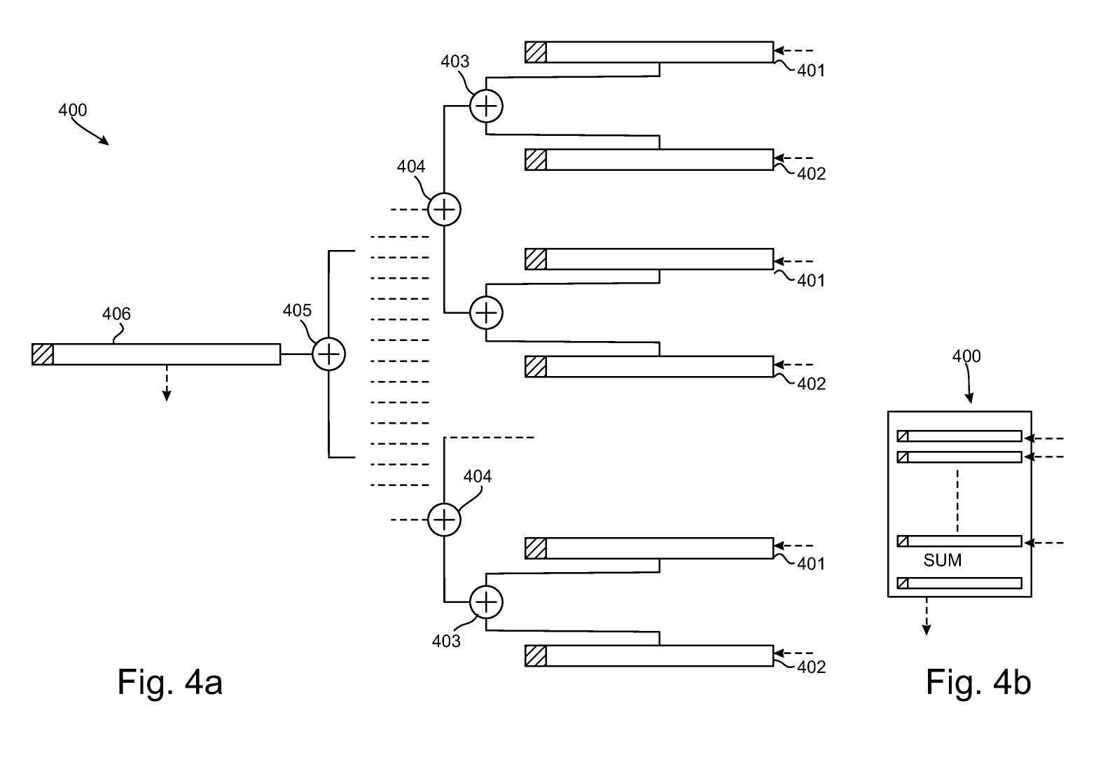

FIG. 4a depicts a tree reduction unit 400, and FIG. 4b depicts a corresponding representation of the logic in a reduced form to be used in further illustrations of the apparatus, in accordance with an embodiment.

Computing sums may be quite often performed tasks, wherein in accordance with an embodiment, the tree reduction unit 400 may be used to carry this part out. Consequently, the run time of a reduction becomes O(log(N)). Floating point numbers are summed in a pair-wise manner as is illustrated with floating point registers 401, 402 and adders 403. The sums are then summed correspondingly in a pair-wise manner by further adders 404 (not shown in FIG. 4a) until there are only two floating point numbers to add by the last adder 405. The final sum may be stored into an output floating point register 406.

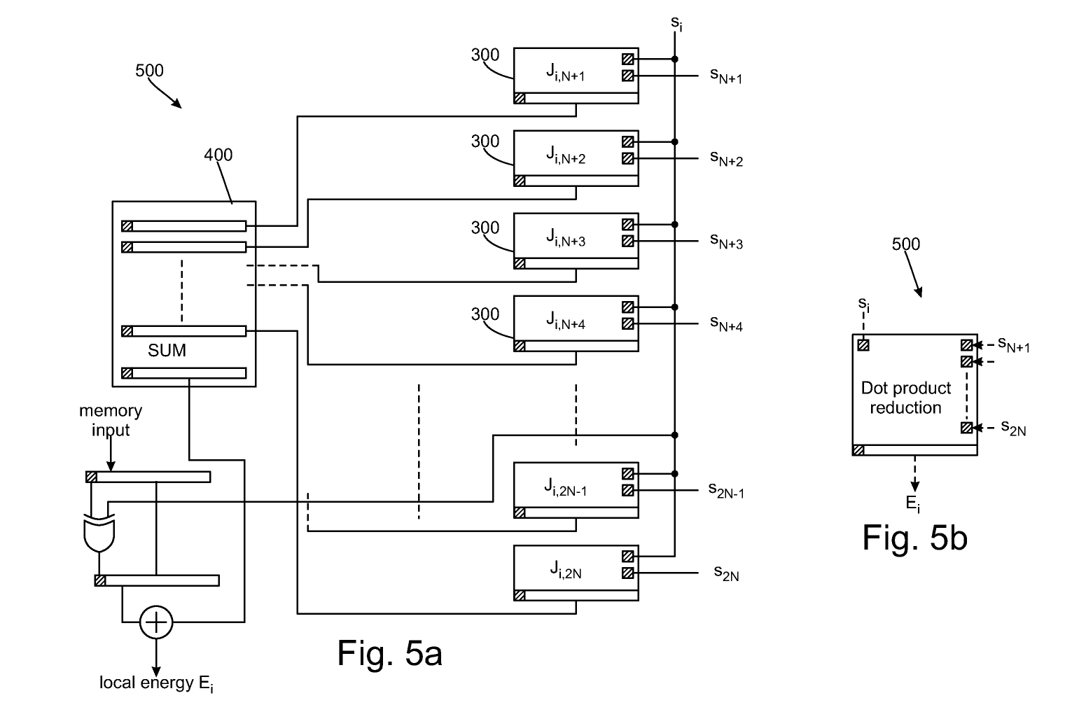

FIG. 5a depicts a vector-vector reduction unit 500, and FIG. 5b depicts a corresponding representation of the logic in a reduced form to be used in further illustrations of the apparatus, in accordance with an embodiment.

Combining the units in FIGS. 3a and 4a, the contribution to the i'th local energy may be computed. For illustrative purposes, it is now assumed that i ∈ [1,N] in which case the resulting reduction is summarized in FIG. 5a as a simplified circuit diagram. Each of the spin multiplication units 300 receive the spin sᵢ as a first input and one of the spins s_{N+1} . . . s_{2N} as a second input. The outputs of the spin multiplication units 300 are summed by the tree reduction unit 400. The variable h, is added to the sum, wherein the vector-vector reduction unit 500 produces as an output the i'th local energy according to Equation (7). As with the tree-reduction the overall run-time of this part is O(log(N)).

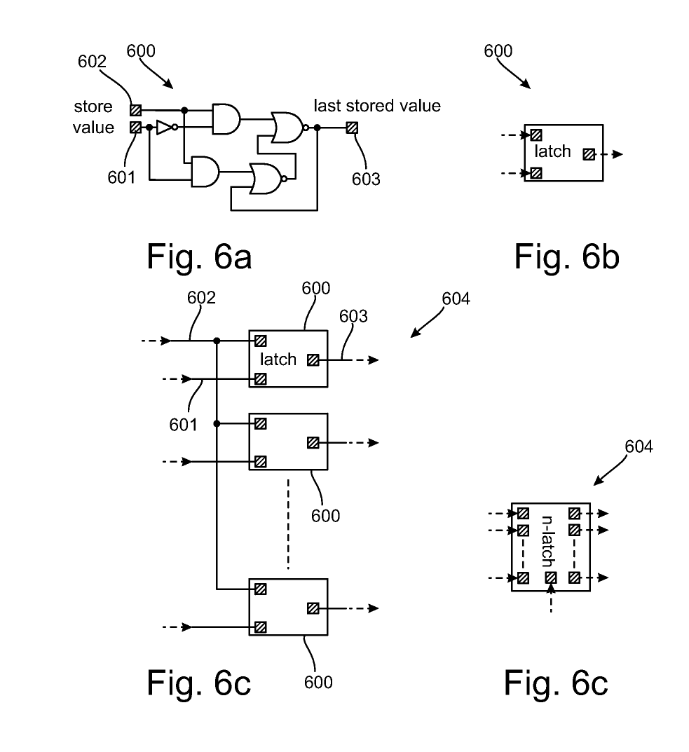

FIG. 6a depicts a latch 600, and FIG. 6b depicts a corresponding representation of the logic in a reduced form to be used in further illustrations of the apparatus, in accordance with an embodiment. The latch 600 comprises a value input 601, a control input 602, and an output 603. When the control input 602 is set to a first state (e.g. high), the output values is set equal to the input value, and when the control input 602 is set to a second state (e.g. low), the output value remains constant independent of the input values. In this specific design the store and value inputs need to be set for a total time of t_{I}=max(tₙₒₜ+t_{and}+tₙₒᵣ; t_{and}+2tₙₒᵣ) to perform storage. The circuitry may need to be altered in the following depending on the random bit source used, therefore the presented implementation should be considered as an example.

FIG. 6c depicts an N-latch 604, and FIG. 6d depicts a corresponding representation of the logic in a reduced form to be used in further illustrations of the apparatus, in accordance with an embodiment. The N-latch 604 comprises a set of latches 600 of FIG. 6a, wherein the N-latch 604 comprises N value inputs 601, a control input 602, and N outputs 603. When the control input 602 is set to a first state (e.g. high), the N output values are set equal to the input values, and when the control input 602 is set to a second state (e.g. low), the output values remain constant independent of the input values. It is worthwhile to point out that any implementation of the above described device can be used in following section, and hence, the implementation details are not limited to this specific implementation.

When the local energy E is computed, computing the exponential θ^{-βΔE} and drawing random numbers in order to decide whether a move is accepted or not may be performed. In some implementations exponentials may be computed by using a lookup table. However, increasing the coupling precision to B bits, the number of energy levels increases exponentially as 2^{B}. Therefore, the corresponding lookup table also grows exponentially and for 32 bits of precision one would need roughly one billion entries. Hence, the corresponding circuit might need extensive optimization in order to operate efficiently and to minimize the space used in a practical realization. In fact, at some B value it may no longer be possible to implement the circuit.

In the following, an embodiment is described in which the exponential function is linearly interpolated. The linear interpolation may be performed e.g. using the IEEE-754 standard. The resulting approximation may have a periodic error and performing an error analysis the error may be reduced to any desired accuracy by choosing the appropriate datatypes and making an error correction table.

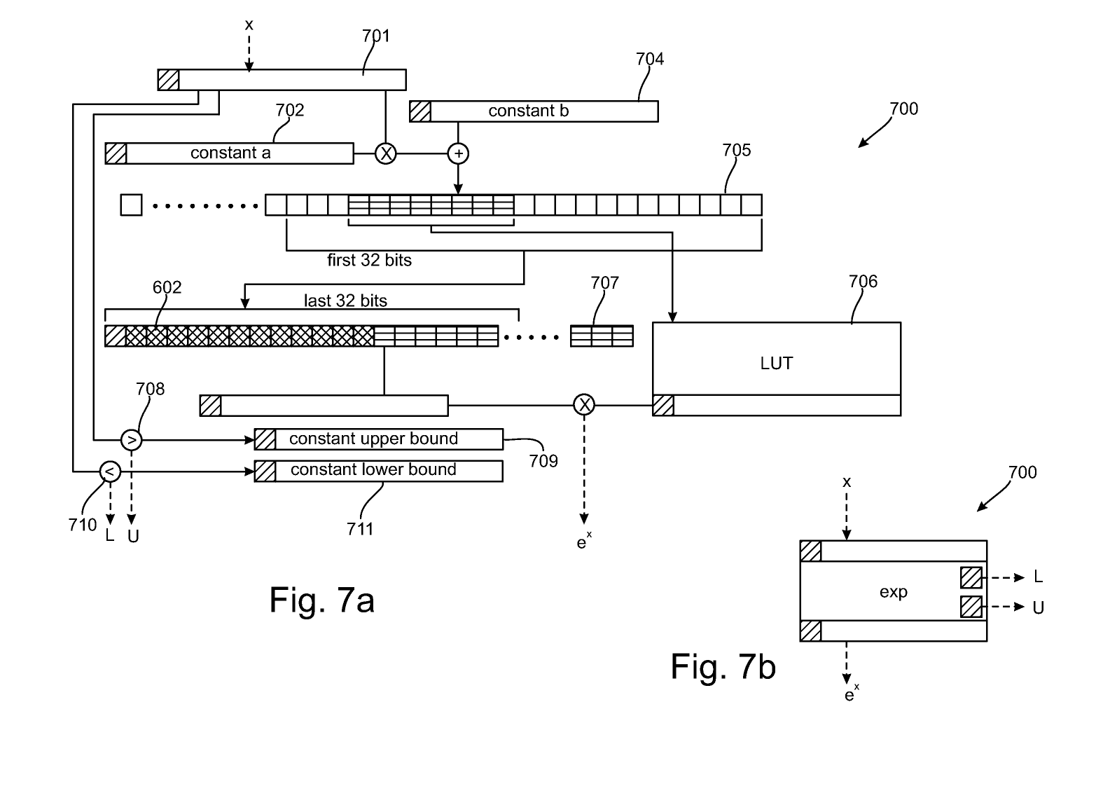

FIG. 7a depicts an example of an exponential approximation unit 700, and FIG. 7b depicts a corresponding representation of the exponential approximation unit in a reduced form to be used in further illustrations of the apparatus, in accordance with an embodiment. This unit takes a single floating-point variable x as an input which is stored into a register 701. The input is multiplied by a first constant a 702. A second constant b 704 is added to the multiplication result. The result of the summation is stored into a floating point register 705. A part of the mantissa of the result of the summation is used as an index to a look-up table (LUT) 706. A purpose of the look-up table 706 is to correct the result of the summation. The look-up table may be preprogrammed or pre-computed lookup. In this example the lookup table uses 256 elements, but this is in general implementation dependent. The input variable to the lookup table may be the bits from bit 12 to bit 20, corresponding to the upper bits in the 52-bit Mantissa after moving the 32-bits from the lower region to the upper region. This is illustrated with the floating point register 707 in FIG. 7a.

The input variable x may also be compared 708 with a constant upper bound 709. If the constant x is greater than the constant upper bound 709, the indication U may be generated. The input variable x may also be compared 710 with a constant lower bound 711. If the constant x is smaller than the constant lower bound 711, the indication L may be generated.

The use of the lookup table 706 may have the advantage that the full exponential function can be implemented with a fairly small amount of logic. Finally, it is noted that this circuit may have many realizations depending on the size of the floating points and the lookup table used. Therefore the implementation in FIGS. 7a and 7b should only be considered as an example of a more general approach, and not as the only realization of this idea.

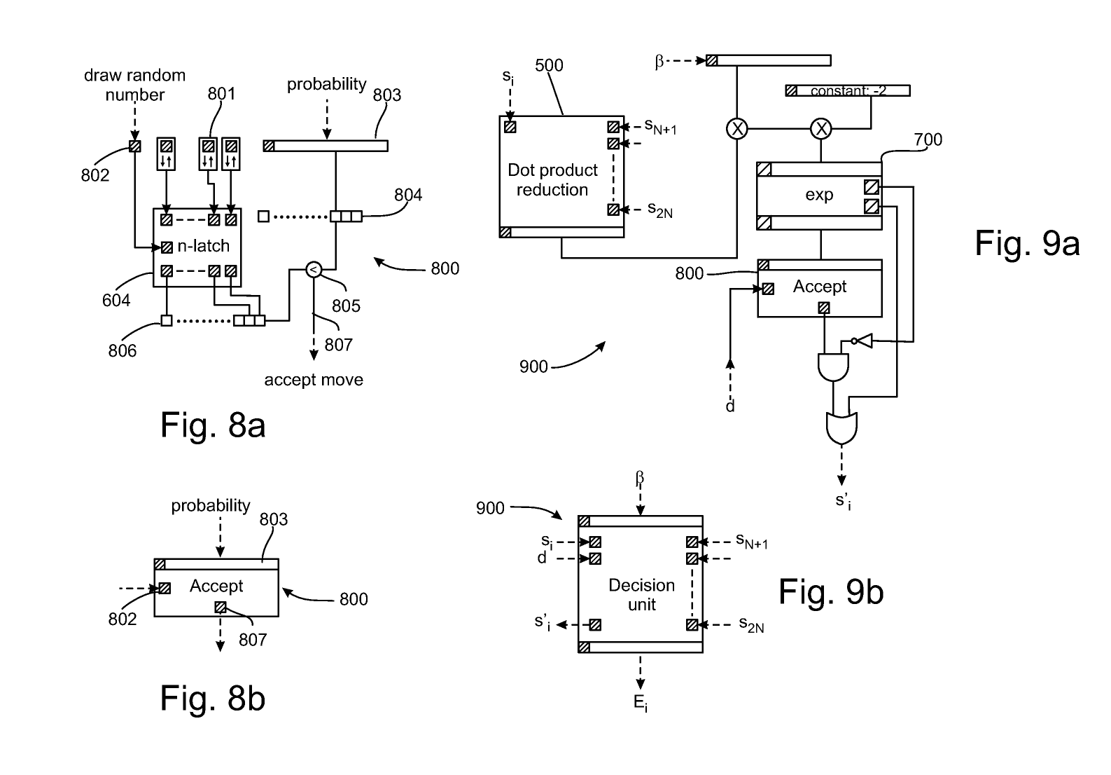

FIG. 8a depicts an accept move decision unit 800, and FIG. 8b depicts a corresponding representation of the logic in a reduced form to be used in further illustrations of the apparatus, in accordance with an embodiment. The accept move decision unit 800 comprises a number of random number generators 801 coupled to an N-latch 604. A control input 802 may be used to control when random numbers generated by the random number generators 801 will be inserted into a random number register 806. The accept move decision unit 800 also comprises a probability input and a register 803 for storing the probability value p. The comparator 805 may be used to compare whether the random number stored in the random number register 806 is smaller than the probability value p or not. If the random number stored in the random number register 806 is smaller than the probability value p, an accept move signal may be generated at the output 807 of the accept move decision unit 800.

The accept move decision unit 800 takes a probability p as input and gives a single bit as output. The output bit will be 1 with probability p. In order to control the decision unit, an additional input bit may be needed: When high the decision units output randomly flipped bits according to p and the output is locked when the additional bit is set to low.

The random bit sources may be white noise generators, deterministic generators (such as linear congruential generators, lagged Fibonacci generators, Mersenne-Twister generators etc.) or quantum random number generators. In this specific implementation we utilise an N-latch to lock the decision for each cycle. If pseudo-random number generators are used, this bit may serve to draw the next pseudo-random number.

In FIG. 8a the random bit generation is illustrated by using individual random number generators 801, but these need not to be individual. For instance, the source of random bits could be a pseudo-random number generator. In the case of a continuous random bit source, an N-latch may be needed to lock the random decision such that the decision remains constant for each cycle.

FIG. 9a depicts a single-spin computation unit 900, and FIG. 9b depicts a corresponding representation of the logic in a reduced form to be used in further illustrations of the apparatus, in accordance with an embodiment. The single-spin computation unit 900 comprises the vector-vector reduction unit 500 which produces as an output the i'th local energy. The single-spin computation unit 900 computes whether a single spin should be updated or not. The vector-vector reduction unit 500 receives the i'th spin sᵢ and the spins of the other half of the bipartite graph to compute the local energy of the i'th spin. The output of the vector-vector reduction unit 500 i.e. the i+th spin's energy multiplied by −2 as to get the energy gain/loss by flipping the spin and the result is further multiplied by the inverse temperature. The quantity −2βΔEᵢ is then fed into the exponential approximation unit 700, and the resulting probability is used as an input in the accept move decision unit 800. It is checked whether the exponential has been over or under-flowing during computation and the result is updated accordingly using standard logic gates. In other words, the random number generating unit 800 determines whether the new spin s, may be accepted or not and on the basis of the determination generates either an accept move signal or an accept move deny signal. Hence, the value of s′ᵢ will remain constant as long as input d is low and may change if d is first set to high for some time and then to low. As long as d is high, the value of s′ᵢ may not be constant.

The two previous units can alternatively be formulated using the logarithm instead of the exponential function. An embodiment of the optimized implementation of the exponential function may be straightforward to inverse in order to compute logarithms instead and the decision module may be straightforward as well.

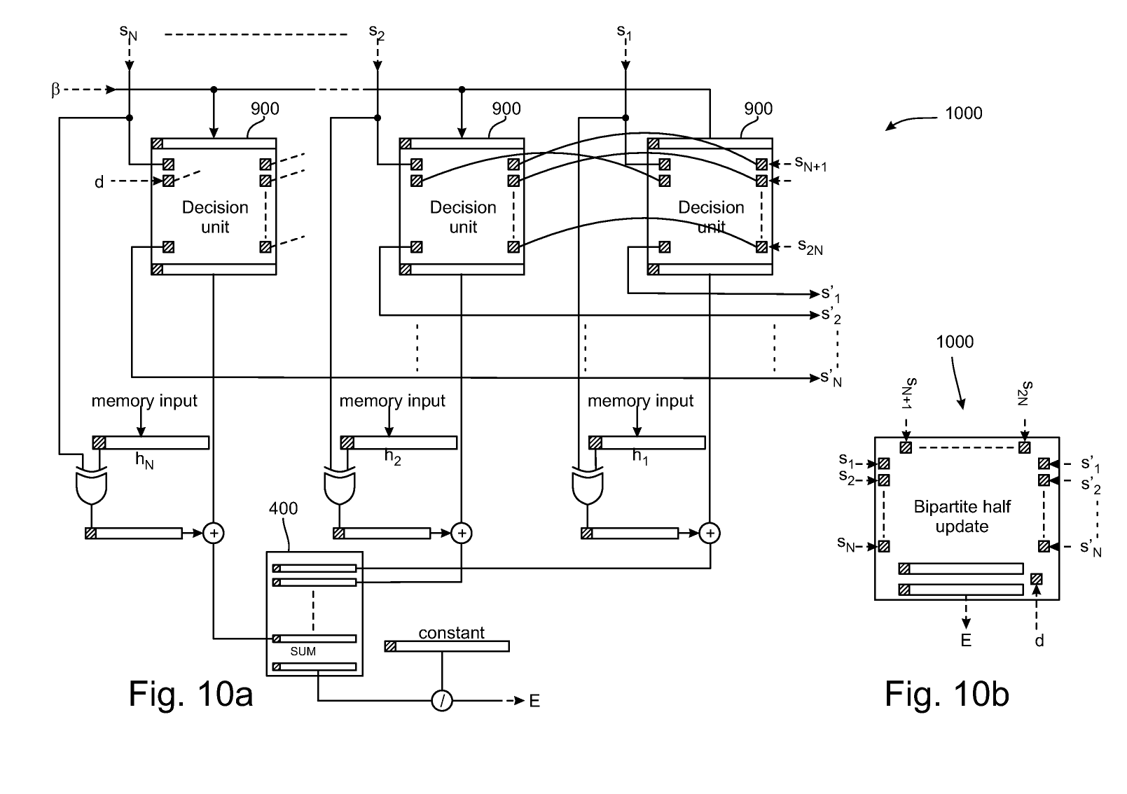

Due to the bipartite structure of the graph half of the 2N spins can be updated in parallel. This may be done by deploying N single-spin update units to obtain a bipartite half update unit 1000 as shown in FIG. 10a. FIG. 10b depicts a corresponding representation of the logic in a reduced form to be used in further illustrations of the apparatus, in accordance with an embodiment.

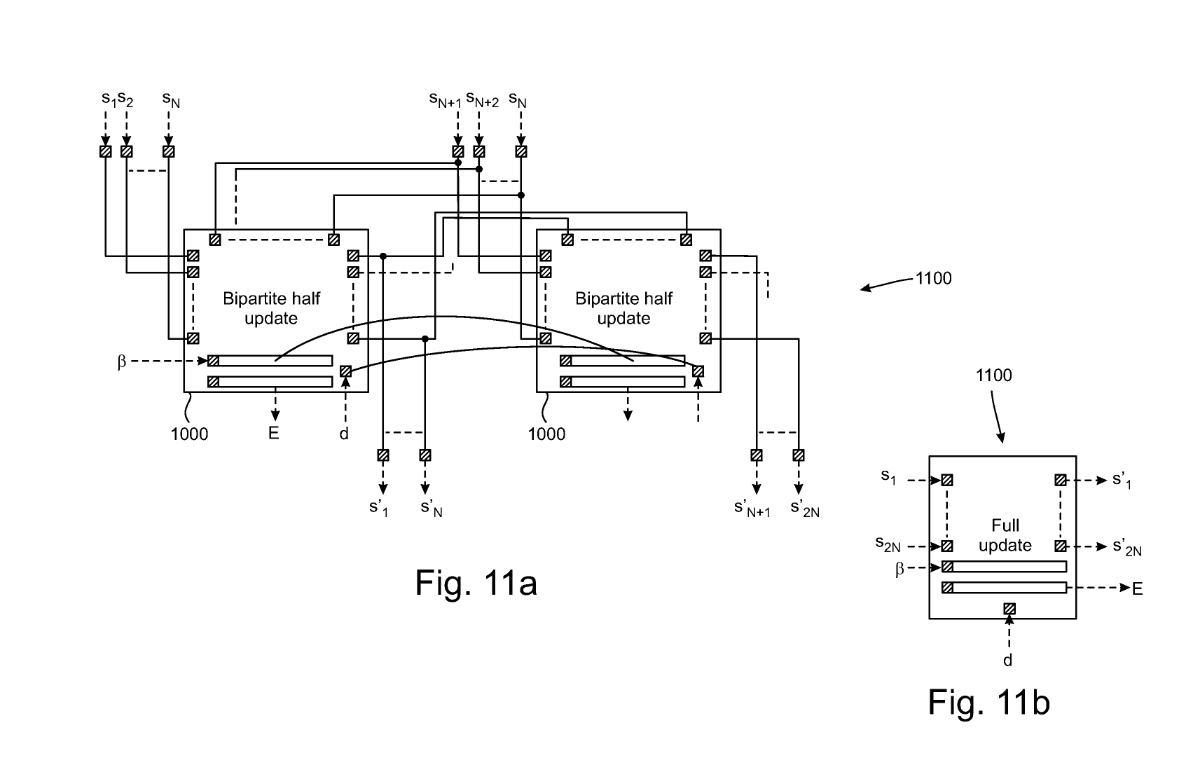

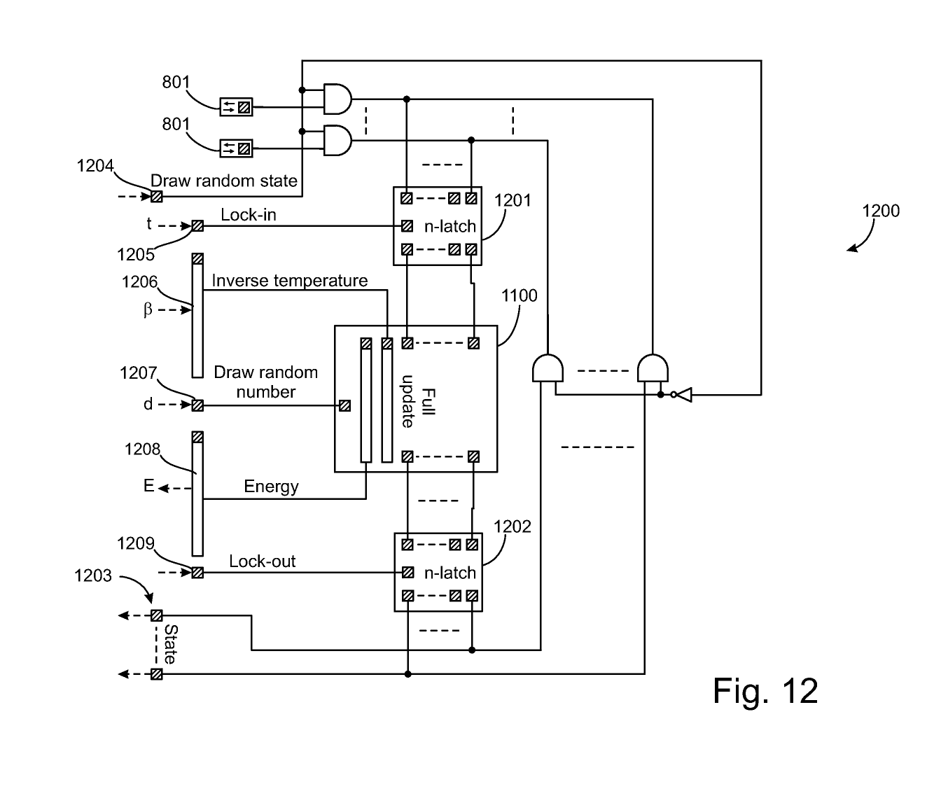

Two bipartite half update units 1000 may be used to update the full graph sequentially as illustrated in FIG. 11a. FIG. 11b depicts a corresponding representation of the logic in a reduced form to be used in further illustrations of the apparatus, in accordance with an embodiment. The energy output of the full update unit 1100 is related to the input values of the spins and not the output values. This value may be used to store the best found state relatively fast and efficiently when the final unit is in use.

Finally, two things are added to the full update unit 1100 to arrive at the final design: First, two 2N-latches are used to lock the state that is currently being processes as well as to lock the output. Second, a method to randomly initialize the input state may also be utilized. The resulting schematics are shown in FIG. 12. The implementation of FIG. 12 comprises the unit in FIG. 11a together with two 2N-latches 1201, 1202 which serve to ensure stability of the calculation. The first latch 1201 serves as a lock to insure that the input remains the same for the time it takes to propagate through the circuit. The second latch 1202 is there to ensure stability when the first latch 1201 is updated. Additionally, the final design includes 2N random bit generators 801, which can be used to initialize the state stored in the first latch 1201 by setting the corresponding input bit t to high. When t is low, it is possible to transfer the state from the second 2N-latch 1202 to the state output 1203.

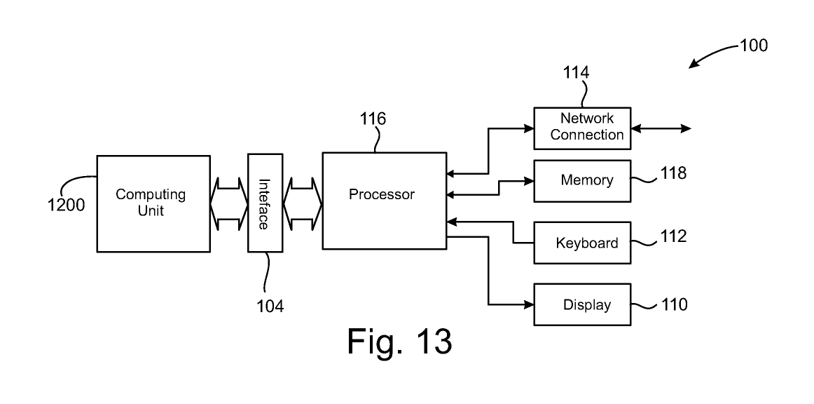

FIG. 13 illustrates an example of a computing device 100 in which the computing circuitry 1200 may be utilized. The computing device 100 may comprise the computing circuitry 1200 implemented e.g. in a FPGA circuit or another programmable circuitry. The inputs and outputs of the computing circuitry 1200 may be connected to an interface circuitry 104 which comprises means for providing information to the computing circuitry 1200, e.g. to initialize some parameters and initial values for the couplings Jᵢⱼ e.g. by setting local floating point memory J[1:2N] into appropriate values, and for obtaining information from the computing circuitry 1200. Information obtained from the computing circuitry 1200 may comprise e.g. computation results.

The computing device 100 may also comprise a display 110 for displaying information to the user, and a keyboard 112 and/or another input device so that the user may control the operation of the computing device 100 and input parameters, variables etc. to be used by the computing circuitry 102. There may also be communication means 114 for communicating with a communication network such as the internet, a mobile communication network and/or another wireless or wired network.

There may also be provided a processor 116 for controlling the operation of the computing device and the elements of the computing device.

In the following the operation of the computing device 100 in utilizing the computing circuitry 1200 will be explained in accordance with an embodiment. For clarity, it is assumed that the state high represents a state in which a bit is set to 1 and the state low represents a state in which a bit is set to 0, but it may also be possible to use different kind of logic.

The local floating point memory J[1:2N] is set into appropriate values according to the problem to be solved. In other words, the couplings J[1:2N] define the problem. The draw random state input 1204 is set to high. Hence, random bits from random number generators 801 are fed to latch 1201. The n-latch 1201 passes values at its inputs to outputs of the n-latch 1201. Then, the lock-in input 1205 is set to high, which transfers the inputs of the n-latch to the outputs of the n-latch 1201. The Draw random state input 1204 may now be set to low to lock the state of the outputs of the n-latch 1201, i.e. the random numbers are locked at the output of the n-latch 1201. Inverse β of the temperature may be entered at the inverse temperature input 1206 and the draw random number input 1207 may be set to high. The computing circuitry 1200 will compute the local energies of the spins to determine whether a single spin should be updated or not, as was described earlier in this specification. The computing device 1200 will wait some time so that the computing circuitry 1200 is able to perform the computation and determination for each spin. When the time has lapsed the draw random number input 1207 may be set to low so that the outputs from the full update module 110 to the n-latch 1202 remain constant. The lock-out input 1209 may be set to high to transfer the inputs of the n-latch 1202 to the outputs of the n-latch 1202. The lock-out input 1209 can now be set to low to lock the status of the outputs of the n-latch 1202.

The calculated energies may be read out at the energy output 1208. Also the states of the spins s′ᵢ may be read out at the state outputs 1203.

The above procedure may be repeated to obtain more output results. The inverse temperature may be the same or may be changed for each repetition time.

In accordance with an embodiment, the above procedure may be repeated until a terminating condition is fulfilled. The terminating condition may be one or more of the following: the solution has been found, a predetermined number of repetitions have been performed, or the change of the local energy between two consecutive repetitions is less than a predetermined value. The last condition may be utilized e.g. in such a way that a result of one execution of the procedure is compared with a result of a result of a previous execution of the procedure and if the difference between the results is less than the predetermined value, the process may be terminated.

It should be noted here that the above mentioned predetermined number of repetitions and predetermined value need not always be the same (a constant value) but may be different in different executions of the procedure. In accordance with an embodiment, the predetermined number of repetitions and/or the predetermined value may depend on the problem to be solved.

The above mentioned inputs, namely the draw random state input 1204, the lock-in input 1205, the inverse temperature input 1206, the draw random number input 1207 and the lock-out input 1209 may be controlled e.g. by the processor 116 either directly by using some output ports of the processor 116, and/or via the interface 104. Correspondingly, the processor 116 may read the status of the outputs of the computing circuitry 1200 either directly by using some input ports of the processor 116, and/or via the interface 104.

The term computer-readable medium is used herein to refer to any medium that participates in providing information to processor 116, including instructions for execution. Such a medium may take many forms, including, but not limited to, non-volatile media, volatile media and transmission media. Non-volatile media include, for example, optical or magnetic disks, such as storage device. Volatile media include, for example, dynamic memory 118. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 17 and 18. A computer-readable medium may comprise a computer-readable storage medium that may be any media or means that can contain or store the instructions for use by or in connection with an instruction execution system, apparatus, or device, such as a computer.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. An apparatus comprising:
a first input for receiving a first set of binary variables and a second set of binary variables;
a first element for storing information regarding interactions between binary variables of the first set and binary variables of the second set;
a second input for receiving an inverse temperature value;
a second element for calculating a change of a local energy of a binary variable of the first set if the binary variable were flipped on the basis of the inverse temperature value and the interactions between the binary variable of the first set and binary variables of the second set;
a third element for calculating a probability on the basis of the change of the local energy;
a fourth element for comparing the probability to a random value to determine whether to accept the flipping of the binary variable of the first set; and
a fifth element for providing an indication whether the flipping can be accepted; and
a sixth element for providing the flipped value of the binary variable of the first set.

2. The apparatus of claim 1, wherein the first element is adapted to store interactions to an initial state on the basis of a problem to be solved.

3. The apparatus of claim 2 further comprising
an output for providing the state of the binary variables after the comparison to determine whether a solution to the problem has been found.

4. The apparatus of claim 1, wherein the second element comprises:
a vector-vector reduction unit adapted to calculate a local energy of a binary variable; and
an exponential approximation unit.

5. The apparatus of claim 1, wherein the apparatus comprises:
a selector for selecting an initial value for the inverse temperature;
the apparatus is configured to calculate the change of the local energy and to determine whether the solution to the problem has been found;
the selector is adapted to increase the inverse temperature value according to a predefined schedule, if the solution has not been found; and
the apparatus is configured to repeat the calculation, and determination and to increase the inverse temperature value until a terminating condition is fulfilled.

6. The apparatus of claim 5, wherein the terminating condition is at least one of the following:
the solution has been found;
a predetermined number of repetitions has been performed;
the change of the local energy between two consecutive repetitions is less than a predetermined value.

7. The apparatus of claim 1, wherein the apparatus comprises:
a plurality of said second element, third element, fourth element, fifth element and the sixth element configured to operate in parallel.

8. The apparatus of claim 1, wherein the apparatus is implemented in a field programmable gate array.

9. The apparatus of claim 1, wherein the apparatus is implemented in an application specific integrated circuit.

10. The apparatus of claim 1, wherein the first input is configured to receive each of the first set of binary variables and the second set of binary variables in parallel.

11. A method comprising:
obtaining a first set of binary variables and a second set of binary variables;
providing information regarding interactions between binary variables of the first set and binary variables of the second set;
providing an inverse temperature value;
calculating a change of a local energy of a binary variable of the first set if the binary variable were flipped on the basis of the inverse temperature value and the interactions between the binary variable of the first set and binary variables of the second set;
calculating a probability on the basis of the change of the local energy;
comparing the probability to a random value to determine whether to accept the flipping of the binary variable of the first set; and
if the comparison indicates that the flipping can be accepted, flipping the value of the binary variable of the first set.

12. The method of claim 11 further comprising:
performing the determination whether the flipping can be accepted to each binary variable of the first set of binary variable and to each binary variable of the second set of binary variables.

13. The method of claim 11 further comprising:
setting the interactions to an initial state on the basis of a problem to be solved.

14. The method of claim 12 further comprising:
reading the state of the binary variables after the comparison to determine whether a solution to the problem has been found.

15. The method of claim 11, wherein calculating a change of a local energy of a binary variable comprises:
computing a local energy by:
multiplying the binary variable of the first set, the binary variable of the second set and the interaction between the binary variable of the first set and the binary variable of the second set;
obtaining a sum of the multiplication results for each binary variable of the first set.

16. The method of claim 14 further comprising:
computing the sums in a pair-wise manner.

17. The method of claim 11 further comprising:
selecting an initial value for the inverse temperature;
calculating the change of the local energy;
determining whether the solution to the problem has been found;
increasing the inverse temperature value according to a predefined schedule, if the solution has not been found; and
repeating the calculation, determination and increment of the inverse temperature value until a terminating condition is fulfilled.

18. The method of claim 17, wherein the terminating condition is at least one of the following:
the solution has been found;
a predetermined number of repetitions has been performed;
the change of the local energy between two consecutive repetitions is less than a predetermined value.

19. The method of claim 11 comprising:
performing the method in parallel to both said first set of binary variables and said second set of binary variables.

20. The method of claim 11 comprising:
obtaining both said first set of binary variables and said second set of binary variables in parallel.

21. A computer readable storage medium stored with code thereon for use by an apparatus, which when executed by a processor, causes the apparatus to perform:
obtain a first set of binary variables and a second set of binary variables;
provide information regarding interactions between binary variables of the first set and binary variables of the second set;
provide an inverse temperature value;
calculate a change of a local energy of a binary variable of the first set if the binary variable were flipped on the basis of the inverse temperature value and the interactions between the binary variable of the first set and binary variables of the second set;
calculate a probability on the basis of the change of the local energy;
compare the probability to a random value to determine whether to accept the flipping of the binary variable of the first set; and
if the comparison indicates that the flipping can be accepted, flip the value of the binary variable of the first set.
